(19) United States
(12) Patent Application Publication
(10) Pub. No.: US 2023/0076764 A1
(43) Pub. Date: Mar. 9, 2023

(54) DEVICE WITH LEVER ELEMENTS TO EXTRACT A BOTTLE CAP

(71) Applicant: FERRARI GROUP S.R.L., Montechiarugolo (PR) (IT)

(72) Inventor: Francesco MARCHINI, Montechiarugolo (PR) (IT)

(21) Appl. No.: 17/899,008

(22) Filed: Aug. 30, 2022

(30) Foreign Application Priority Data
Sep. 2, 2021 (IT) 202021000004352

(51) Int. Cl. B67B 7/06

(52) U.S. Cl. CPC B67B 7/066

(57) ABSTRACT

Device for extracting a mushroom-type cap from a bottle, including a casing, adapted to house a mushroom-shaped cap, including a lower base, arranged towards the bottle and an upper base arranged towards the top of the cap, two lever-type locking devices, placed specularly in seats present on the side surface of the casing, rotating and pivoted to the casing, adapted to assume an engagement position in which the locking device engages the cap to lock it inside the casing and facilitate the extraction thereof. The locking device including a work surface facing the inside of the casing, the work surface being concave and shaped to adhere to the head of the cap and including a knurling. The work surface being inclined to converge towards the inside and towards the lower base, when the locking device is in the engagement position.

The present invention fits into the field of the devices used to extract a cork with a typical mushroom shape from the neck of bottles, in particular of sparkling wine and/or champagne.

The prior art uses various types of devices to extract the cap of bottles of sparkling wine and/or champagne.

One type consists of, for example, clamp corkscrews. Said devices are essentially second-degree levers, in which the resistant force (placed by the cap) lies between the fulcrum and the force applied by the user's hand.

Another type is represented by those devices, consisting of a hollow casing, in which the cap to be extracted is inserted when it is screwed or inserted by interference on the bottle.

This latter type can also provide for a cap ejection system, consisting, for example, of a cylinder placed on the top of the casing itself and coaxial to the cap retained within the casing and to be ejected.

The main disadvantage of these latter devices is that the cap, once inserted inside the casing, is retained only thanks to the friction that is created between the inner surface of the casing and the head of the cap itself. This causes the occurrence of slippages between the head of the cap and the inner surface of the casing during the rotation, necessary to extract said cap, which does not result in the cap itself being effectively tightened.

Furthermore, the rounded shape of these devices does not facilitate manual gripping and the application of a rotation force. Therefore, slippages occur between the hand of the person performing the operation and the outer surface of the device.

Aim of the present invention is to provide a further device for the extraction of mushroom-shaped caps, in particular of sparkling wine and/or champagne, of the type comprising a casing and cap ejection systems, capable of optimally locking the cap before extraction, compressing it laterally through lever-type locking means.

Said device characterized in that it comprises:

a casing adapted to house a substantially mushroom-shaped cap;

two lever-type locking means, placed specularly in two seats present on the side surface of the casing, rotating and pivoted to said casing, adapted to assume an engagement position in which said locking means engage with the cap to lock it inside the casing and facilitate the extraction thereof.

In particular, said locking means comprise a work surface facing the inside of the casing, said work surface preferably being concave and shaped so as to adhere to the head of the cap.

Further, said work surface comprises a knurling.

Preferably said work surface is inclined so as to be convergent towards the inside of the device, in a top-down direction, when the locking means are in the engagement position.

In this way, when the locking means engage, the work surface tends to exert an upwardly directed force so as to push the cap towards the extraction direction.

Advantageously, the knurling allows to increase the friction between the surface of the cap and the device, eliminating slippages when the locking elements are in the engagement configuration and a rotation force is applied.

Preferably, said knurling has a diamond shape with a plurality of protrusions preferably with pointed shape, preferably arranged according to parallel rows vertically and/or horizontally adapted to form a matrix of protrusions on the surface.

Advantageously, the diamond shape penetrates the surface of the cap, when the locking elements are in the engagement configuration.

In this way, by applying a rotation to the device, together with a vertical translation away from the bottle, the user is able to extract the cap from the bottleneck by exerting a higher and more effective force allowing a better grip and preventing the cap from slipping.

In addition, the locking means comprise an arm protruding vertically above said casing; the arm allows the entire user's hand to tighten the locking means in the engagement position and thus facilitate the extraction of the cap.

Therefore, said protruding arms make the device more ergonomic reducing slippages between the user's hand and the device itself.

Advantageously, the locking means comprise a pin, adapted to engage in a concave space present in each seat of the casing and around which each locking means rotates. The presence of the pin allows the locking means to move from the insertion position, in which the user can easily insert the device on the cap, to the optimal engagement position for the extraction of the cap.

The main advantage of the device object of the present invention is, therefore, to make an effective tightening of the head of the mushroom-shaped caps by means of said lever-type locking means, not present in the devices of the prior art.

Said objects and advantages are achieved by the device and by the method for extracting the cap, for example of a bottle of sparkling wine and/or champagne, object of the present invention, which are characterized by the provisions of the following claims.

This and other features will become more apparent from the following description of a preferred illustrated embodiment, by way of non-limiting example in the accompanying drawings.

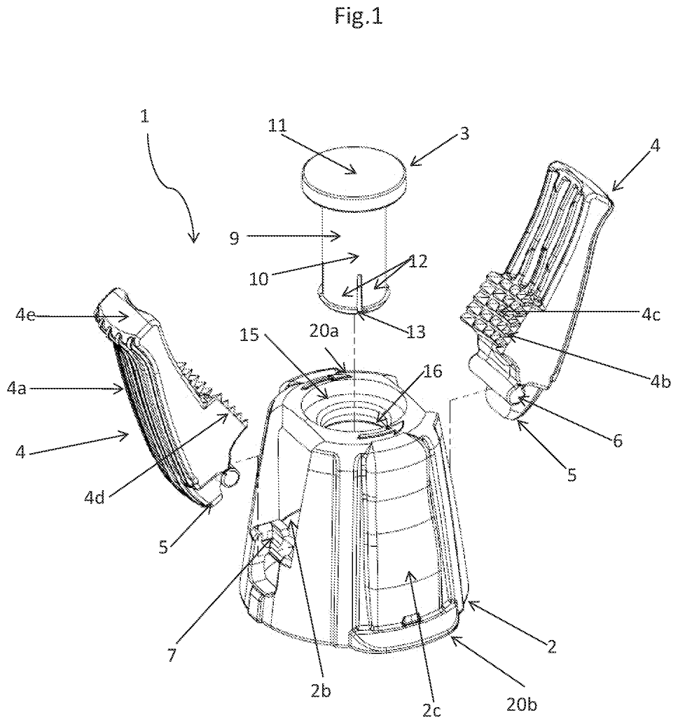

FIG. 1: illustrates, in a perspective view, an exploded view of the device to extract the cap of a bottle;

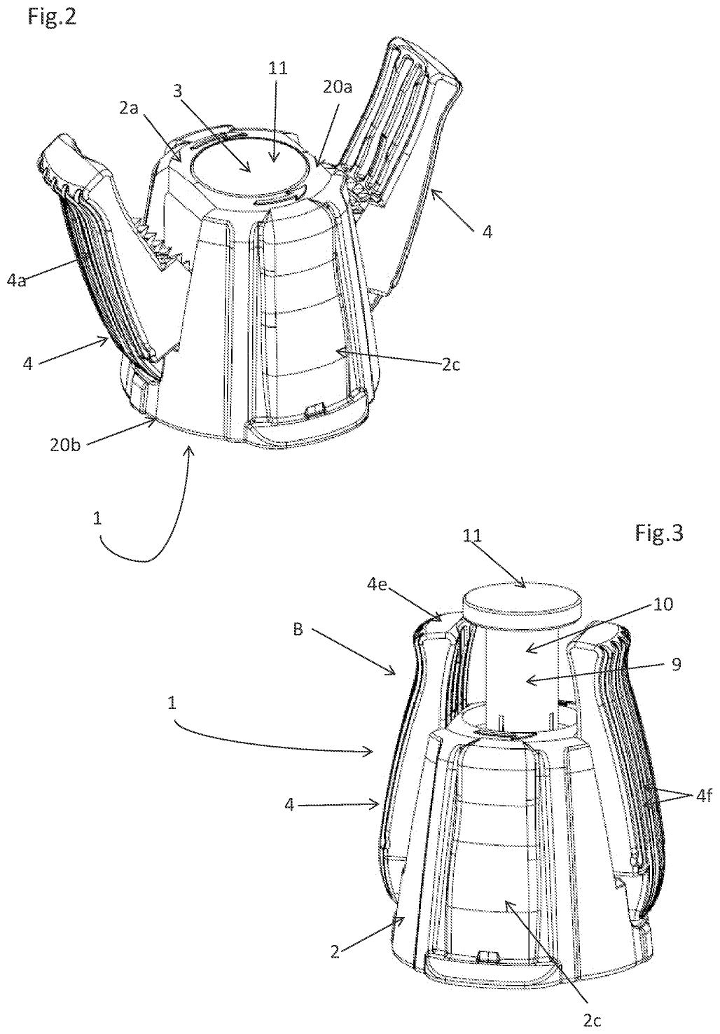

FIG. 2: illustrates a further perspective view of the device;

FIG. 3: illustrates a further perspective view of the device in the engagement configuration;

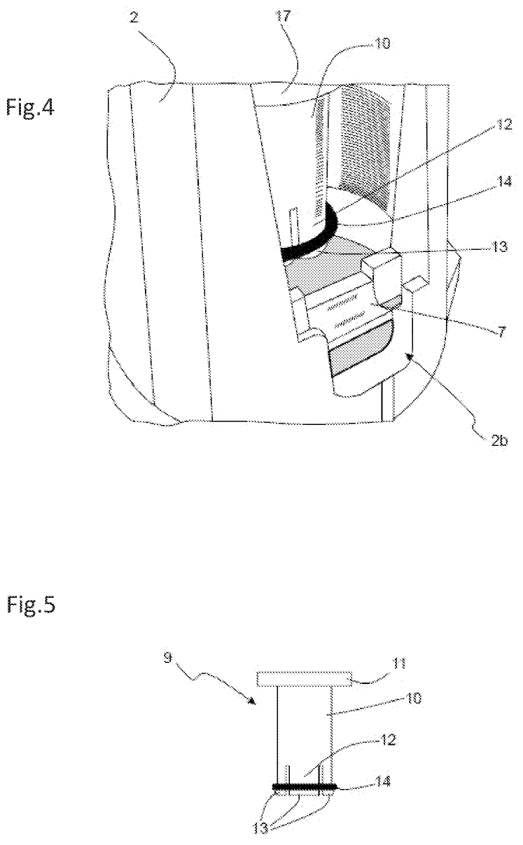

FIG. 4: illustrates, in a perspective view, a seat of a locking means of the device of FIG. 1;

FIG. 5: illustrates a detail of the device in elevation;

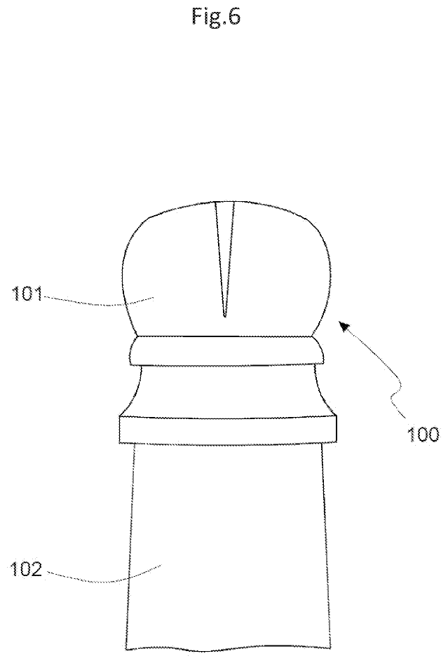

FIG. 6: illustrates, in a side view, a portion of a bottle with a mushroom-shaped cap;

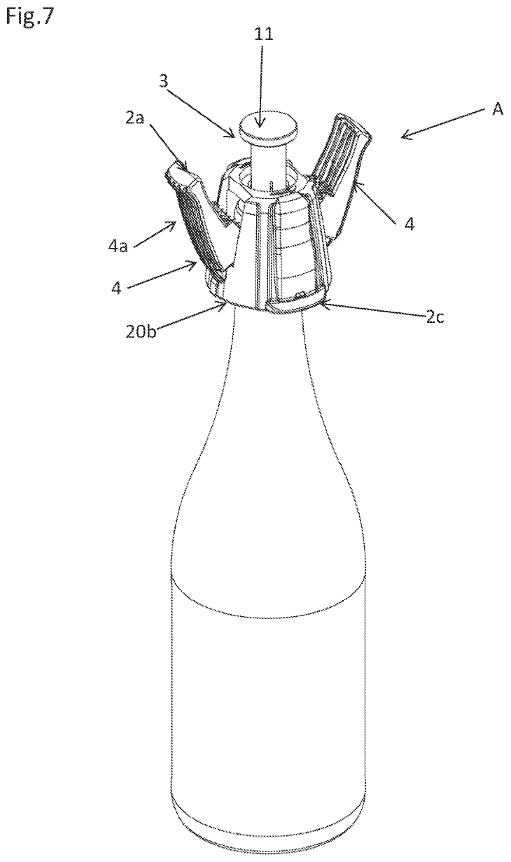

FIG. 7: illustrates, in a side view, the device in insertion configuration on a bottleneck;

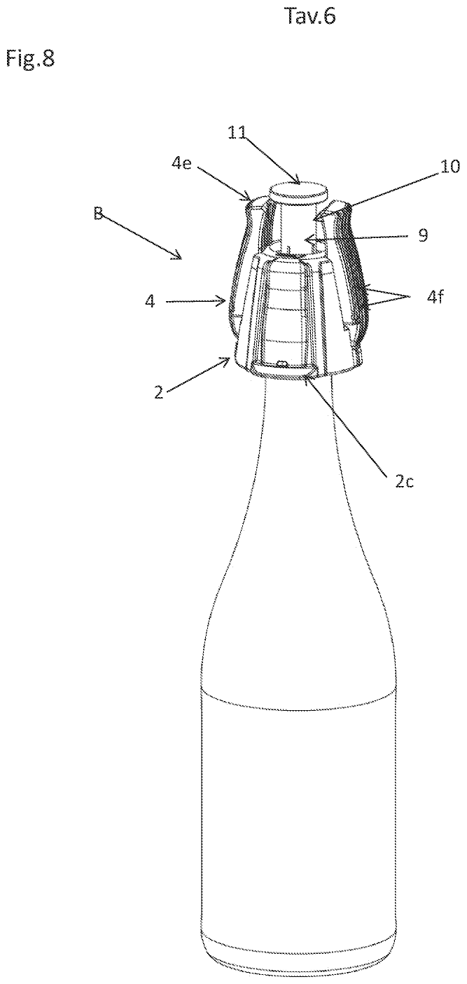

FIG. 8: illustrates in a side view, the device in engagement configuration on a bottleneck.

With particular reference to the figures, a device to extract the cap 100 of a bottle 102, for example of sparkling wine and/or champagne, is globally indicated with 1.

Said device 1 is of the type comprising a casing 2, with substantially truncated-conical shape.

Said casing 2 is adapted to house a mushroom-shaped cap 100, and an ejection system 3 for the cap 100, coaxial to the cap 100 itself, placed on the top 2a of said casing 2.

The device 1 has a truncated-conical shape so that when it is in a work or engagement position B, a lower base 20b thereof, arranged towards the bottle 102, has a diameter greater than an upper base 20a thereof arranged towards the top 2a of said casing 2 and the top of the cap 100.

The device 1 also comprises two lever-type locking means 4, placed specularly in two seats 2b present on the side surface of the casing 2, rotating and pivoted to said casing 2.

Said locking means 4 are adapted to assume an engagement position B in which said locking means 4 engage with the cap 100 to lock it inside the casing 2 and facilitate the extraction thereof.

In particular, each locking means 4 comprises an arm 4a of said lever, protruding vertically with respect to said casing 2, to allow and facilitate a manual intervention during the step of inserting the casing 2 around the cap 100; each locking means 4 can furthermore comprise at least one pin 6 preferably placed near a lower end 5 of each locking means 4; said pin 6, acts as a rotation fulcrum and is adapted to engage in a concave space 7 of the seat 2b of the casing 2 and around which the locking means 4 itself rotates.

Said locking means 4, as the name itself implies, have the function of locking the cap 100 inside the casing 2 when the latter is placed above the bottle 102.

This function of locking the cap 100 inside the casing 2 will be described in more detail below.

Since said two locking means 4 are completely identical, for simplicity's sake, only one of the two will be referred to below.

A locking means 4, therefore, can summarily comprise:

said arm 4a protruding above said casing 2;

a work surface 4b protruding towards the inside of the casing 2; said surface 4b being concave and shaped so as to adhere to the head 101 of the cap 100 and comprising a knurling 4c that generates friction and improves the grip of the device 1 on the cap 100; said work surface 4b comprises a side profile 4d that is inclined so as to be convergent towards the inside and towards the lower base 2b of the casing 2, when the locking means 4 are in the engagement position B;

said pin 6, preferably placed below the surface 4b, preferably near a lower end 5 and adapted to engage in a concave space 7 present in each seat 2b of the casing 2 and around which each locking means 4 rotates.

Any constructive variants are considered to fall within the same scope of protection.

For example, a design form not depicted in the figure, can provide a device 1 with locking means 4 comprising the arm 4a that works with a lever opposed to that depicted in the figures, that is, the arm 4a rotates around a pin 6 or fulcrum placed above the surface 4b and with the pressing part, adapted to be grasped with the hand, placed below said rotation fulcrum or pin 6.

Preferably, the parts of the locking means 4 facing outwards of the device 1 are shaped so as to increase friction with the hand of a user, in particular with vertical strips 4f arranged side by side and protruding.
Preferably, the arm 4a protrudes above said casing 2 by a height of at least 10 mm, preferably between 10 and 40 mm, preferably 20 mm.
Preferably, the knurling 4c comprises a so-called diamond shape.
In particular, the diamond shape comprises a plurality of protrusions preferably with pointed shape. Said protrusions are preferably arranged according to parallel rows vertically and/or horizontally adapted to form a matrix of protrusions on the surface 4b.

Said ejection system 3 for the cap 100 comprises a cap-pushing cylinder 9, coaxial to the cap 100 itself and placed on a top 2a of said casing 2. Said cylinder 9 consists of a hollow tubular body 10 and of a head 11 (of larger diameter than the tubular body 10).

As shown in FIG. 5, said hollow tubular body 10 ends, on the side opposite the head 11, with a plurality of teeth 12 each having a shoulder 13.

Said teeth 12 ensure that the pin 9, during assembly of the device 1, is easily insertable (and removable) inside a through hole 16 present in a recess 15 on the top 2a of the casing 2.

As can be seen in the figures, the shoulder 13 retains a sealing element 14, by way of example an O-Ring, which, during the step of ascent of the pin 9, corresponding to the insertion of the cap 100 inside the casing 2, prevents the removal of the pin 9 itself through the through hole 16.

It should be noted that, during the ascent step, the pin 9 is kept in the guide by a lead-in 17 present below the through hole 16 in the side underlying the top 2a of the casing 2.

In particular, said locking means 4 have two main positions:

one of insertion (A), in which the cylinder 9 is partially outside the casing 2 and the locking means 4 have the upper ends 4e spread apart; in this configuration, the surface 4b comprising the knurling 4c is at the height of the head 101 of the cap 100;

one of engagement (B) in which, the cylinder 9 is at its maximum exposure outside the casing 2 and the locking means 4 again have the arms 4a approaching; in this configuration, the surface 4b wraps the head 101 of the cap 100 with the knurling 4c.

Advantageously, said work surface 4b with knurling 4c allows the head of the cap to be gripped optimally and to prevent the casing 2 from slipping during the step of uncorking the bottle 102.

Preferably, between one seat 2b and the other one, the casing 2 has ergonomic grips 2c for the user's hand.

Operationally, the user wishing to uncork a bottle 102 bearing a cork 100 with a mushroom-shaped head 101, like for examples bottles 102 of sparkling wine and/or champagne, places the device 1 above said bottle 102 so as to insert the head 101 of the cap 100 inside the casing 2. In doing so, the ejection system 3 lifts up pushed by the cap 100 itself, and the locking means 4 rotate in their seat 2b around the cylinders 6 moving into the insertion position (A).

By continuing the operation of inserting the device 1 on the cap 100, the locking means 4 place themselves in the engagement position (E).

At this point, the user, by applying with one hand a force F on each locking means 4, causes the arms 4a to approach each other and the knurling 4c to engage against the head 101 of the cap 100 tightening it stably inside the casing 2.

Finally, by applying a rotation to the device 1 together with a vertical translation away from the bottle 102, the user is able to extract the cap 100 from the neck of the bottle 102.

Finally, in order to extract the cap 100 from device 1, the cylinder 9 is lowered, holding the rest of the device 1 in place.

1. A device for extracting a mushroom-type cap from a bottle, for example of sparkling wine and/or champagne, comprising
a casing adapted to house a substantially mushroom-shaped cap comprising a lower base, configured to be arranged towards the bottle and an upper base thereof arranged towards the top of the cap,
two lever-type locking means, placed specularly in two seats present on the side surface of the casing, rotating and pivoted to said casing, adapted to assume an engagement position in which said locking means engage with the cap to lock it inside the casing and facilitate the extraction thereof, characterized in that said locking means comprise:
a work surface facing the inside of the casing, said work surface preferably being concave and shaped so as to adhere to the head of the cap and comprising a knurling and said work surface is inclined so as to be convergent towards the inside and towards the lower base of the casing, when the locking means are in the engagement position.

2. The device according to claim 1, wherein the locking means, comprise an arm protruding vertically above said casing.

3. The device according to claim 1, wherein the arm protrudes above said casing by a height of at least 10 mm, preferably between 10 and 40 mm.

4. The device according to claim 1, wherein the knurling comprises a diamond shape with a plurality of protrusions preferably with pointed shape, preferably arranged according to parallel rows vertically and/or horizontally adapted to form a matrix of protrusions on the surface.

5. The device according to claim 1, wherein the locking means comprise a pin, is adapted to engage in a concave space present in each seat of the casing and around which each locking means rotates.

6. The device according to claim 1, wherein the pin is placed below the work surface.

7. The device according to claim 1, comprising at least one ejection system for the cap, in turn comprising at least one cap-pushing cylinder, coaxial to the cap itself and placed on a top of said casing.

8. The device according to claim 7, wherein said cap-pushing cylinder, comprises a tubular body and a head, which in the steps of ejecting the cap places itself in a recess present on the top of the casing positioning itself in abutment against the top itself of the casing.

9. The device according to claim 9, wherein said tubular body is hollow and has a plurality of teeth; said teeth ending with a shoulder having the function of retaining a sealing element.
